(19) United States
(12) Patent Application Publication
(10) Pub. No.: US 2014/0148533 A1
(43) Pub. Date: May 29, 2014

(54) NANO CARBON REINFORCED COMPOSITE AND A METHOD OF MANUFACTURING THE SAME

(71) Applicant: Arup Kumar Chatterjee, Mumbai (IN)

(72) Inventor: Arup Kumar Chatterjee, Mumbai (IN)

(73) Assignee: SP I-CANNANO RESEARCH PRIVATE LIMITED, Mumbai (IN)

(21) Appl. No.: 14/113,978

(22) PCT Filed: Apr. 25, 2012
(86) PCT No.: PCT/IN12/00304

§ 371 Date: Feb. 13, 2014

(30) Foreign Application Priority Data
Apr. 25, 2011 (IN) 1301/MUM2011

(51) Int. Cl. C08K 13/02

(52) U.S. Cl. CPC C08K 13/02
USPC 524/35; 264/239

(57) ABSTRACT

A carbon Nano material reinforced composite including carbon Nano material, calcium Nano scaled material, resin material such as phenolic resin or a modified form thereof including epoxy modified phenolic resin, alkyd modified phenolic resin and natural fiber or any modified processed form thereof. The carbon Nano material and calcium Nano scaled material are dispersed in the resin material along with the natural fiber and/or any modified form thereof. Along with the Nano scaled calcium material, optionally, other Nano scaled material such as Nano zinc oxide, Nano alumina, Nano silica, Nano Iron Oxide, Nano Silver, Nano copper, or Nano Zirconium, or any combination thereof can be used as per the requirement. The composite has strength similar to or better than the plywood.

### FIELD OF INVENTION

The present invention is directed to a composite and a method of manufacturing the same. In particular to Nano Carbon reinforced Composite and method of manufacturing the same. As per the present invention, method of manufacturing/preparing the said resultant Nano carbon reinforced composite product is very simple and cost-effective. The invention involves the use of Carbon Nano material such as carbon Nano fiber and/or carbon Nano tube, resin matrix/material and natural fiber including cloth, jute, rice husk, bagasse, beetle nut shell, coconut fiber, grass or any other agricultural waste or any other modified form thereof. As per the present invention, optionally the said Nano carbon reinforced composite may also contain other Nano scaled material such as Nano zinc oxide, Nano alumina, Nano silica, Nano Iron Oxide, Nano Silver, Nano copper, or Nano Zirconium or any combination thereof.

### PRIOR ART

The use of Plywood is known in the industry. However, plywood has its own drawbacks and/or limitations. Excessive use of plywood is going to depreciate the forest. Hence there is a scope/need to develop a composite material, which will replace the use of plywood; also the composite material, which is stronger and long lasting than plywood. The present invention provides a unique, simple and cost effective method of manufacturing a polymer based “Nano-Carbon Reinforced Composite” that would almost replace the use of plywood.

The International U.S. Pat. No. 5,169,710, has disclosed the composite material comprising discrete layers formed of continuous fiber embedded in a matrix resin, the layers being separated or spaced normally apart by laminar regions or layers comprising matrix resin filled with finely-divided particulate modifier such as “polyamide resin” in the form of particles having an essentially spheroidal, spongy structure, also described as “porous polyamide particles”. However, this patent does not involve use of carbon Nano material. The said invention also claims use of thermoplastic material.

U.S. Pat. No. 7,28,5591 has disclosed a method for preparing nanotube composite material and fibres that provide exceptional nanotube alignment and dispersion. This patent, is directed to use of elongated electrical insulator and does not involve use of thermosetting composites or fabric based composites.

The main difficulty with the composites of the present invention includes (a) difficulty in proper chemical interaction of Nano carbon material (carbon Nano fiber and/or carbon Nano tube) with resin material/matrix (e.g. phenolic resin or any modified form thereof); (b) wetting of said resin material on the surface of the natural fiber or modified form thereof.

### SUMMARY OF THE INVENTION

As per the present invention, the composite, in particular, Nano carbon material reinforced composite comprises of carbon Nano material, calcium Nano scaled material of about (0.1 to 5% w/w), resin material (of about 20 to 80% w/w), and natural fiber or any modified form thereof (of about 20 to 80% w/w). The resulting composite shows increased strength, which is many times higher than conventional material like plywood, wood, fiber boards, plastic boards. Besides, such material is not UV resistant whereas the resultant Nano reinforced composites material is highly UV resistant. The resin material is selected from any phenolic resin or any other modified form thereof including epoxy modified phenolic resin, alkyd modified phenolic resin. As per the present invention, optionally the said Nano carbon reinforced composite may also contain other Nano scaled material such as Nano zinc oxide, Nano alumina, Nano silica, Nano Iron Oxide, Nano Silver, Nano copper, or Nano Zirconium or any combination thereof.

### DESCRIPTION OF DRAWINGS

FIG. 1: It is a flow chart of the method of manufacturing Nano carbon reinforced composite;

FIG. 2: It is a schematic diagram of the Chemical Vapor Deposition (“CVD”) setup; wherein (A)—Vaporizing furnace, (B)—pyrolysing furnace, (C)—quartz tube, (D)—quartz boat with ceramic substrate, (E)—quartz boat with precursor, (F)—flow regulator, (G)—gas cylinder, H—gas bubbler.

### DETAILED DESCRIPTION OF THE INVENTION

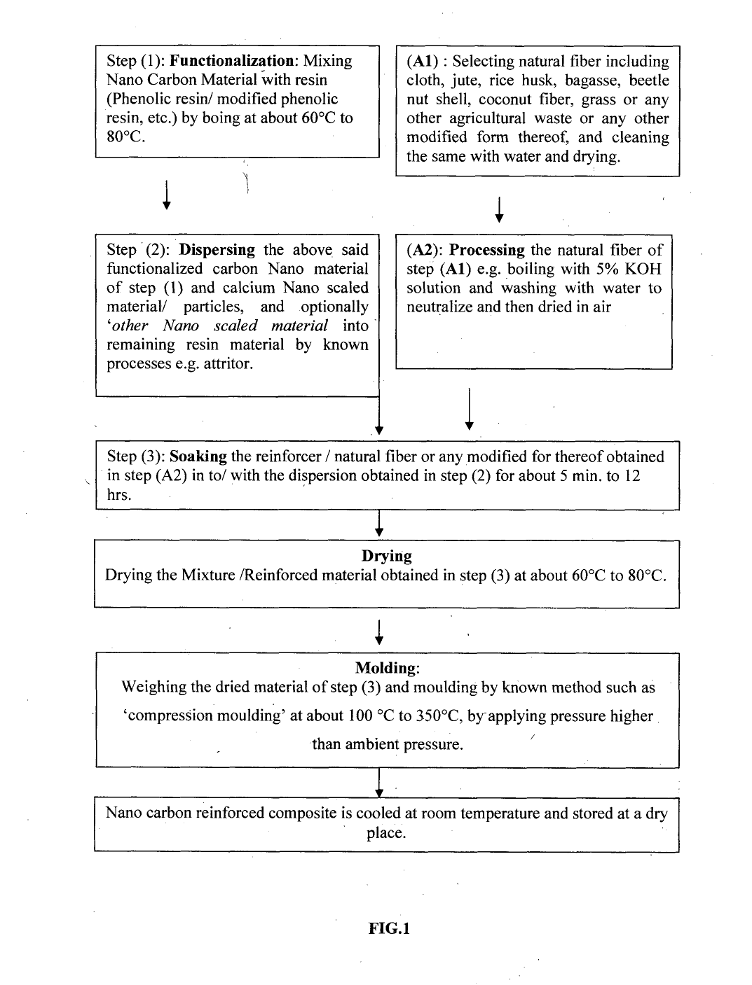

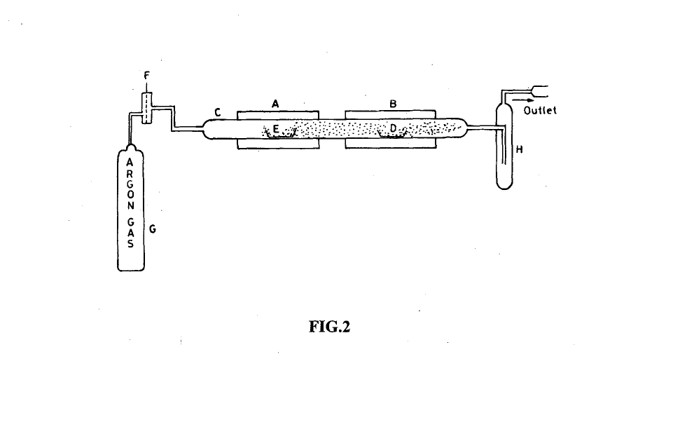

The present invention may be more readily understood by reference to the following detailed description as more readily brought out in Flow Chart (FIG. 1), FIG. 2 Schematic diagram of the CVD setup, which is only illustrative and in no way limit the scope of the invention.

As per the present invention, the carbon Nano material reinforced composite comprises of carbon Nano material, calcium Nano scaled material, phenol resin material or modified form thereof, and natural fiber or modified form thereof wherein the carbon Nano material and calcium Nano material are dispersed in the phenol resin material or modified form thereof including epoxy modified phenolic resin, alkyd modified phenolic resin along with the natural fiber and/or any modified form thereof.

As per one of the preferred embodiment of the present invention, the carbon Nano material reinforced composite comprises of (a) carbon Nano material of about 0.1 to 5% w/w, (b) calcium Nano scaled material of about 0.1 to 2% w/w; (c) phenol resin material or modified form thereof including epoxy modified phenolic resin, alkyd modified phenolic resin of about 20 to 80% w/w; and (d) natural fiber or any modified/processed form thereof of about 20 to 80% w/w: wherein the carbon Nano material and calcium Nano scaled material are dispersed in the phenol resin or any modified form thereof including epoxy modified phenolic resin, alkyd modified phenolic resin material along with the natural fiber and/or any modified form thereof.

The above said Nano carbon reinforced composite may optionally further contain Nano zinc oxide, Nano alumina, Nano silica, Nano Iron Oxide, Nano Silver, Nano copper, or Nano Zirconium or any combination thereof.

As per one of the preferred embodiments of the present invention, the resin material is selected from any phenolic resin(s) or any other modified form thereof including epoxy modified phenolic resin, alkyd modified phenolic resin.

As per the present invention, the natural fiber or any other modified form thereof includes cloth, jute, rice husk, bagasse, beetle nut shell, coconut fiber, grass or any other agricultural waste or any other modified form thereof.

### Processing:

The method of producing/manufacturing Nano carbon reinforced composite is illustrated by way of schematic flow chart in FIG. 1

Carbon Nano Material:

The carbon Nano materials can be synthesized by known Chemical Vapour Deposition (“CVD”) method including as discussed in ‘Chatterjee et al PhD thesis IIT Mumbai, 2004, Energy System Eng.’ As per Chatterjee et al PhD thesis IIT Mumbai, 2004, Energy System Eng.’, the CVD unit consist of two furnaces joined side by side with a quartz tube traversing both of them. The furnace (A) was used to vaporize turpentine oil (organic precursor) and the furnace (B) was used to pyrolyse the turpentine oil vapors. The vapor was carried over from A by a stream of Argon gas. A quartz boat (E) containing 2 ml of turpentine oil was placed in furnace A (maintained at about 200° C.). The temperature of the furnace (B), containing a quartz boat (D) with the Nano catalyst at. 900° C. After deposition of transition metal as discussed in Chatterjee et al PhD thesis HT Mumbai, 2004, Energy System Eng., furnaces were cooled down and carbon Nano fiber from the boat (D) was collected. By using different catalyst and conditions different Nano forms of Nano carbon are developed/grown/produced as described in Chatterjee et al PhD thesis IIT Mumbai, 2004, Energy System Eng. Then carbon is purified to remove Nano material catalysts and used for the further procedure.

The morphological characterization of carbon Nano materials were done by Scanning Electron Microscopy (SEM-JEOL JSM-840). It was found ‘Nano carbon fibers’ are substances shaped like cylindrically wound sheets of carbon atoms arranged in a hexagonal mesh and having a diameter of 20 to 100 nm (nanometers) and a length of 2-3 micron. These substances are called, e.g., Nano-carbon fibers or Nano-carbon tubes, since they have a Nano-sized diameter.

### Functionalization of Nano Material and Dispersion:

As per the present invention, in step one (1) carbon Nano material (Carbon nano fiber) is boiled with a portion of resin material at about 60° C. to 80° C. for a period of about 15 min. to 5 hours.

As per the present invention, the resin may be phenolic resin or any modified form of phenolic resin. The modified phenolic resin includes epoxy modified phenolic resin, alkyd modified phenolic resin, etc.

As per one of the embodiment of the present invention in step 1 (one), carbon Nano material of about 0.1% w/w to 5% w/w is mixed with a portion about 5% w/w to 20% w/w of the resin material out whole of 20% w/w to 80% w/w resin material by boiling at about 60° C. to 80° C. for a period of about 15 min. to 5 hrs.

Thus, the dispersion of carbon Nano material with a portion of the phenolic resin is carried out at a temperature higher than the ambient temperature. In particular, the functionalization of the carbon Nano material by dispersing with the phenolic resin material or any modified form thereof is carried out at a temperature of about 60° C. to 80° C. for a period of about 15 min. to 5 hours.

As per the present invention, In step (2), functionalized carbon Nano material obtained in step (1) and calcium Nano scaled material is dispersed in the remaining resin material by means of known methods e.g. grinding with attritor.

As per one of the embodiment of the present invention, the total amount/quantity of the said resin material is about 20% w/w to 80% w/w. Out of which, a portion of about 5 w/w to 20% w/w of the said resin material is used in step one (1) for the functionalization of carbon Nano material and the remaining resin material is used in the subsequent step (2) as discussed herein above.

As per the present invention, in step two (2), along with the calcium Nano scaled particles, optionally, ‘other Nano scaled material’ may be dispersed in the said resin material/matrix. Such ‘other Nano scaled material’ may be selected from Nano zinc oxide, Nano alumina, Nano silica, Nano Iron Oxide, Nano Silver, Nano copper, or Nano Zirconium or any combination thereof. Selection of such optional Nano material depends upon the requisite customized properties of the product e.g. fire resistant, scratch resistance, U.V. protection, etc.

As per the present invention, ‘other Nano scaled material’ may be selected from Nano zinc oxide, Nano alumina, Nano silica, Nano Iron Oxide, Nano Silver, Nano copper, or Nano Zirconium or any combination thereof and the same can be obtained from the method(s) described in Chatterjee et al PhD thesis HT Mumbai, 2004, Energy System Eng.

As per one of the preferred embodiments, in step (2), about 0.1% w/w to 2% w/w of Nano zinc oxide, Nano alumina, Nano silica, Nano Iron Oxide, Nano Silver, Nano copper, or Nano Zirconium, or any combination thereof can be dispersed in the said resin material along with the calcium Nano scaled material.

Residual carbon' of phenolic resin has certain drawbacks limiting application of phenolic resin as binding agent. Basically these drawbacks arise from glassy structure of ‘residual carbon’ which results in low mechanical strength and poor oxidation resistance versus graphite phase structure. As per the present invention, the formation of graphite phase after heating of residual carbon derived from the resin disables above shortcomings in respect to properties of residual carbon of phenolic resin.

Reinforcement:

As per the present invention, the reinforcement material/natural fiber are porous. As per the present invention the ‘reinforcement material’ is selected from the group such as natural fibers including cloth, jute, rice husk, bagasse, beetle nut shell, coconut fiber, grass or any other agricultural waste or any other modified form thereof.

As per the present invention the selected natural fiber is optionally cleaned with water and dried. The said fiber material is processed as per the known methods. The said natural fiber may be boiled with alkali and then neutralized with water and then dried. As per the present invention, KOH may be used at a concentration of about 5% w/w.

As per the present invention, in step (3), the mixture obtained in step (2) is soaked with about 20% w/w to 80% w/w of natural fibers and/or any processed or modified form thereof for about 5 min. to 12 hrs.

Drying and Moulding:

The processed material obtained in step three (3) above can be dried and then moulded.

As per the present invention, drying of the said mixture obtained in step (3) can be carried out at temperature of about 60° C. to 80° C., and subsequently the said dried material can be moulded. The known techniques of moulding can be used. As per the present invention, a process of “compression moulding” is used. Accordingly moulding is carried out by applying pressure higher than the ambient pressure. In particular, as per the preferred embodiment of the present invention, the moulding can be carried out at temperature of about 100° C. to 350° C. by applying pressure of about 0.2 to 2 ton/square inch for about 5 min. to 1 hr.

The Nano carbon reinforced composite of the present invention, is cooled at room temperature and stored at a dry place.

As per one of the preferred embodiments of the present invention, the Nano carbon reinforced composite can be obtained in solid form. As per the present invention, the said Nano carbon reinforced composite can be cooled at room temperature and/or stored at a dry place.

It is observed that “different percentages of Carbon Nano material along with the resin matrix” shows varied properties, some of which are illustrated in the following examples. However, the said examples in no way limit the scope of the invention.

It is observed that the Nano carbon reinforced composite as per the present invention is strong. In particular, the strength of the Nano carbon reinforced composite is similar to or higher than any plywood.

The following Examples would explain/describe the present invention and suitable composition having different tensile strength, sheer strength, flexural strength are stated in tabular format shown below the examples. It also compares the ultimate tensile strength and other qualities with those of wood.

### Example—1

### Sample Identification Code—CP 17B

The following composition was taken in % w/w.

| | Weight (% |
|---|---|
| Ingredient material | w/w) |
| 1.5% w/w Nano carbon material/fiber | 30 |
| dispersed phenolic resin | |
| Nano scaled calcium | 2 |
| Nano scaled zinc oxide | 2 |
| Nano scaled silica solution | 1 |
| Colorant | 1 |
| Jute cloth | 64 |

The paste was made using 1000 rpm attrition with all above ingredient material except jute cloth. The said paste was manually applied on jute cloth. After drying, the prepared material was pressed in a hydraulic press under pressure 175 kg/cm2 and temperature of about 150° C. for about 15 min.

### Example—2

### Sample Identification Code—CP 17D

The following composition was taken in % w/w.

| | Weight (% |
|---|---|
| Ingredient material | w/w) |
| 1.5% Nano carbon dispersed phenolic resin | 40 |
| Nano scaled calcium | 2 |
| Nano scaled zinc oxide | 2 |
| Nano scaled silica solution | 1 |
| Colorant | 1 |
| Jute cloth | 54 |

The paste was made using 1000 rpm attrition with all above ingredient material except jute cloth. The said paste was manually applied on jute cloth. After drying, the prepared material was pressed in a hydraulic press under pressure 175 kg/cm2 and temperature of about 150° C. for about 15 min.

### Example—3

### Sample Identification Code—CP 17E

The following composition was taken in % w/w.

| | Weight (% |
|---|---|
| Ingredient material | w/w) |
| 1.5% Nano carbon dispersed phenolic resin | 50 |
| Nano scaled calcium | 2 |
| Nano scaled zinc oxide | 2 |
| Nano scaled silica solution | 1 |
| Colorant | 1 |
| Jute cloth | 44 |

The paste was made using 1000 rpm attrition with all above ingredient material except jute cloth. The said paste was manually applied on jute cloth. After drying, the prepared material was pressed in a hydraulic press under pressure 175 kg/cm2 and temperature of about 150° C. for about 15 min.

### Example—4

### Sample Identification Code—CP 17G

The following composition was taken in % w/w.

| | Weight (% |
|---|---|
| Ingredient material | w/w) |
| 1.5% Nano carbon dispersed phenolic resin | 60 |
| Nano scaled calcium | 2 |
| Nano scaled silica solution | 1 |
| Colorant | 1 |
| Jute cloth | 36 |

The paste was made using 1000 rpm, attrition with all above ingredient material except jute cloth. The said paste was manually applied on jute cloth. After drying, the prepared material was pressed in a hydraulic press under pressure 175 kg/cm2 and temperature of about 150° C. for about 15 min.

### Example—5

### Sample Identification Code—CP 17H

The following composition was taken in % w/w.

| | Weight (% |
|---|---|
| Ingredient material | w/w) |
| 1.5% Nano carbon dispersed phenolic resin | 60 |
| Nano scale calcium | 2 |
| Nano scaled zinc oxide | 2 |
| Nano scaled silica solution | 1 |
| Colorant | 1 |
| Jute cloth | 34 |

The paste was made using 1000 rpm attrition with all above ingredient material except jute cloth. The said paste was manually applied on jute cloth. After drying, the prepared material was pressed in a hydraulic press under pressure 175 kg/cm2 and temperature of about 150° C. for about 15 min.

### Example—6

### Sample Identification Code—CP 17 I

The following composition was taken in % w/w.

| | Weight (% |
|---|---|
| Ingredient material | w/w) |
| 1.5% Nano carbon dispersed phenolic resin | 70 |
| Nano scaled calcium | 2 |
| Nano scaled zinc oxide | 2 |
| Nano scaled silica solution | 1 |
| Colorant | 1 |
| Jute cloth | 24 |

The paste was made using 1000 rpm attrition with all above ingredient material except jute cloth. The said paste was manually applied on jute cloth. After drying, the prepared material was pressed in a hydraulic press under pressure 175 kg/cm2 and temperature of about 120° C. for about 15 min.

TABLE 1
comparing various samples of Nano Carbon Reinforced Composite:

| | | | Sample Identification Code | | | | | | |
|---|---|---|---|---|---|---|---|---|---|
| | | | Plywood | | | | | | |
| Sr. | | | 12 mm | | | | | | |
| No. | Property | Units | thick | CP-17 B | CP-17 D | CP-17 E | CP-17 G | CP-17 H | CP-17 I |
| 1 | Determination of | % | 11.32 | ND | 7.53 | 6.21 | ND | 8.17 | 5.59 |
| | Moisture | | | | | | | | |
| 2 | Density | gm/cm3 | 0.881 | ND | 1.306 | 1.361 | ND | 1.381 | 1.397 |
| 3 | Tensile Strength | N/mm2 | 50.02 | 32.82 | 30.17 | 33.27 | 25.82 | 34.78 | 54.53 |
| 4 | Avg. Modulus | N/mm2 | 6340.27 | 6005.67 | 8188.58 | 6876.58 | 7215.22 | 5454.54 | 15419.46 |
| | Elasticity | | | | | | | | |
| 5 | Modulus of | N/mm2 | 64.08 | 47.34 | 44.3 | 47.23 | 52.11 | 48 | 58.96 |
| | Rupture | | | | | | | | |
| 6 | Compressive | N/mm2 | 16.77 | 12.16 | 18.05 | 13.76 | 23.18 | 27.39 | 94.12 |
| | Strength | | | | | | | | |
| 7 | Impact | — | 0.27 mm | ND | No | No | ND | No | 0.08 mm |
| | Resistance test | | Indentation | | indentation as | indentation as | | indentation | Indention. |
| | | | | | such | such | | as such | Also |
| | | | | | observed | observed | | | cracking & |
| | | | | | | | | | tearing not |
| | | | | | | | | | observed |
| 8 | Nails & Screw | — | — | ND | Nail could not | Nail could | ND | Nail Could | Screw/Nail |
| | Holding Power | | | | advance in the | not advance | | not advance | could not |
| | | | | | specimen | in the | | in the | advance in |
| | | | | | being very | specimen | | specimen | the |
| | | | | | stiff and non- | being very | | being very | specimen |
| | | | | | fibrous | stiff and | | stiff and non- | being very |
| | | | | | material | non-fibrous | | fibrous | stiff and |
| | | | | | | material | | material. | hard |
| 9 | Avg. Max. Load | (Kg) | 260 | ND | Nail could not | Nail could | ND | Nail Could | Screw/Nail |
| | for Withdrawal of | | | | advance in the | not advance | | not advance | could not |
| | Nail | | | | specimen | in the | | in the | advance in |
| | | | | | being very | specimen | | specimen | the |
| | | | | | stiff and non- | being very | | being very | specimen |
| | | | | | fibrous | stiff and | | stiff and non- | being very |
| | | | | | material | non-fibrous | | fibrous | stiff and |
| | | | | | | material | | material. | hard |
| 10 | Avg. Max. Load | (Kg) | 387.5 | ND | Nail could not | Nail could | ND | Nail Could | Screw/Nail |
| | for Withdrawal of | | | | advance in the | not advance | | not advance | could not |
| | Screw | | | | specimen | in the | | in the | advance in |
| | | | | | being very | specimen | | specimen | the |
| | | | | | stiff and non- | being very | | being very | specimen |
| | | | | | fibrous | stiff and | | stiff and non- | being very |
| | | | | | material | non-fibrous | | fibrous | stiff and |
| | | | | | | material | | material. | hard |

*ND: Not Done

### Advantages:

Nano carbon based Nano reinforced composite material obtained has strength which is many times higher than conventional material like plywood, wood, fiber boards, plastic boards. Besides, such material is not UV resistant whereas the resultant Nano reinforced composites material is highly UV resistant. Some of the said material e.g. plywood, during rainy season absorbs moisture which tends to reduce the bonding of the plywood layer as also deteriorates the strength, however the Nano Composite material according to this invention is water resistant and therefore can be used in all seasons. Nano Composite material is available at cheaper rate.

Further modifications and variations will become apparent to those skilled in the resin formulating and composite manufacturing area, and such modifications and variations will be included within the scope of the invention as defined by the claims.

1. A composite comprising of:
(a) carbon Nano material of about 0.1 to 5% w/w;
(b) calcium Nano material of about 0.1 to 2% w/w;
(c) resin material of about 20 to 80% w/w; and
(d) natural fiber of about 20 to 80% w/w;
wherein the carbon Nano material and calcium Nano scaled material are dispersed in the resin material along with the natural fiber and/or any modified form thereof.

2. The composite of claim 1, having about 0.1 to 2% w/w Nano zinc oxide, Nano alumina, Nano silica, Nano Iron Oxide, Nano Silver, Nano copper, or Nano Zirconium or any combination thereof.

3. The composite of claim 1, wherein the resin material is selected from any phenolic resin(s) or any other modified form thereof including epoxy modified phenolic resin or alkyd modified phenolic resin.

4. The composite of claim 1, wherein the natural fiber or any other modified form thereof includes cloth, jute, rice husk, bagasse, beetle nut shell, coconut fiber, grass or any other agricultural waste or any other modified form thereof.

5. A method of producing/manufacturing a composite comprising the steps of:
(a) mixing carbon Nano material of about 0.1% w/w to 5% w/w with about 5% w/w to 20% w/w of the resin material out of the total of 20% w/w to 80° A) w/w resin material and boiling the said mixture at about 60° C. to 80° C. for a period of about 15 min. to 5 hours;
(b) dispersing the mixture obtained in step (a) and calcium Nano scaled particles into the remaining resin material for a period of about 5 min. to 30 min.;
(c) soaking the mixture obtained in step (b) with about 20% w/w to 80% w/w of natural fibers and! or any processed or modified form thereof for about 5 min. to 12 hrs.;

6. The method of manufacturing a composite of claim 5, wherein in step (b) about 0.1 to 2% w/w Nano zinc oxide, Nano alumina, Nano silica, Nano Iron Oxide, Nano Silver, Nano copper, or Nano Zirconium, or any combination thereof is dispersed.

7. The method of manufacturing the composite of claim 5, comprising of drying the said mixture obtained in step (c) at temperature of about 60° C. to 80° C., and then molding the said dried material at temperature of about 100° C. to 350° C. by applying pressure higher than ambient pressure for about 5 min. to 1 hr.

8. The method of manufacturing a composite of claim 5, comprising of drying the said mixture obtained in step (c) at temperature of about 60° C. to 80° C., and then molding the said dried material at temperature of about 100° C. to 350° C. by applying pressure of about 0.2 to 2 ton/square inch for about 5 min. to 1 hr.

9. The method of manufacturing a composite of claim 5, wherein the resin material is selected from phenolic resin(s) or any other modified forms thereof including epoxy modified phenolic resin or alkyd modified phenolic resin.

10. The method of manufacturing the composite of claim 5, wherein the natural fiber or any other modified form thereof includes cloth, jute, rice husk, bagasse, beetle nut shell, coconut fiber, grass or any other agricultural waste or any other modified form thereof.

11. The composite of claim 2, wherein the resin material is selected from any phenolic. resin(s) or any other modified form thereof including epoxy modified phenolic resin or alkyd modified phenolic resin.

12. The composite of claim 2, wherein the natural fiber or any other modified form thereof includes cloth, jute, rice husk, bagasse, beetle nut shell, coconut fiber, grass or any other agricultural waste or any other modified form thereof.

13. The composite of claim 3, wherein the natural fiber or any other modified form thereof includes cloth, jute, rice husk, bagasse, beetle nut shell, coconut fiber, grass or any other agricultural waste or any other modified form thereof.

14. The method of manufacturing the composite of claim 6, comprising of drying the said mixture obtained in step (c) at temperature of about 60° C. to 80° C., and then molding the said dried material at temperature of about 100° C. to 350° C. by applying pressure higher than ambient pressure for about 5 min. to 1 hr.

15. The method of manufacturing a composite of claim 6, comprising of drying the said mixture obtained in step (c) at temperature of about 60° C. to 80° C., and then molding the said dried material at temperature of about 100° C. to 350° C. by applying pressure of about 0.2 to 2 ton/square inch for about 5 min. to 1 hr.

16. The method of manufacturing a composite of claim 6, wherein the resin material is selected from phenolic resin(s) or any other modified forms thereof including epoxy modified phenolic resin or alkyd modified phenolic resin.

17. The method of manufacturing the composite of claim 6, wherein the natural fiber or any other modified form thereof includes cloth, jute, rice husk, bagasse, beetle nut shell, coconut fiber, grass or any other agricultural waste or any other modified form thereof.
